(19) United States
(12) Patent Application Publication
(10) Pub. No.: US 2012/0099295 A1
(43) Pub. Date: Apr. 26, 2012

(54) LIGHTING DEVICE, DISPLAY DEVICE, TELEVISION RECEIVER AND METHOD OF MANUFACTURING LIGHTING DEVICE

(75) Inventor: Masashi Yokota, Osaka (JP)

(73) Assignee: SHARP KABUSHIKI KAISHA, Osaka-shi, Osaka (JP)

(21) Appl. No.: 13/381,722

(22) PCT Filed: Jun. 15, 2010
(86) PCT No.: PCT/JP2010/060100

§ 371 Date: Dec. 30, 2011

(30) Foreign Application Priority Data
Jul. 9, 2009 (JP) 2009-163015

(51) Int. Cl. G02F 1/13357; B23P 17/00; G09F 13/04

(52) U.S. Cl. 362/97.2; 362/97.1; 29/426.2

(57) ABSTRACT

It is an object of the present invention to provide a lighting device realizing cost reduction. A lighting device of the present invention includes a plurality of LEDs 16, an LED board 40 on which the LEDs 16 are mounted, and a chassis 14 to which the LED board 40 is attached. The LED board 40 has a rectangular frame-shape. The LED board 40 includes a first board 40A1 and a second board 40A2 attached to the chassis 14. The second board 40A2 having an outer shape smaller than that of the first board 40A1 may be provided inside the first board 40A1 in a plan view.

### TECHNICAL FIELD

The present invention relates to a lighting device, a display device, a television receiver and a method of manufacturing a lighting device.

### BACKGROUND ART

In recent years, display elements of image display devices including television receivers are shifting from conventional cathode-ray tube displays to thin-screen display devices to which thin-screen display elements including liquid crystal panels and plasma display panels are applied. This enables the display device to be thinner. A liquid crystal display device requires a backlight unit as a separate lighting device because a liquid crystal panel used therein is not a light-emitting component. Examples of the backlight units include a backlight unit described in the following Patent Document 1. In the backlight unit described in Patent Document 1, a light source unit is configured by linearly arranging a plurality of LEDs (light sources) on a rectangular board, and the light sources are two-dimensionally arranged by arranging the plurality of light source units.

Patent Document 1: Japanese Unexamined Patent Publication No. 2007-317423

### Problem to be Solved by the Invention

In order to provide a low-cost backlight unit to a customer, cost reductions of the backlight unit is always required. For cost reduction, it is effective to reduce costs of components of the backlight unit, particularly the plurality of boards arranged, and there is room for improvement in this point.

### DISCLOSURE OF THE PRESENT INVENTION

The present invention was accomplished in view of the above circumstances. It is an object of the present invention to provide a lighting device realizing cost reduction. It is another object of the present invention to provide a display device and a television receiver including the lighting device. It is still another object of the present invention to provide a method of manufacturing the lighting device.

### Means for Solving the Problem

To solve the above problem, a lighting device of the present invention includes a plurality of light sources, a rectangular frame-shaped board on which the light sources are mounted, and aboard attaching member to which the board is attached. When the light sources are two-dimensionally provided on the board attaching member, for examples, the plurality of light sources is arranged along the long-side direction of the strip-shaped board. The plurality of strip-shaped boards is considered to be arranged along the short-side direction thereof. In the present invention, the rectangular frame-shaped boards having four sides are used, and thereby, the total number of the boards can be reduced (to about half) as compared with a configuration including the strip-shaped boards when the light sources of the same line number are provided. Reduction in the total number of the boards facilitates attaching work of the boards, and thereby work cost can be reduced. In the sense that the total number of the boards is reduced, it is best to set the number of the boards to one. However, when the board is configured by one sheet, the total weight and area of the boards are unpreferably increased. Because the mounting places of the light sources can be changed in extending directions (two directions) of four sides included in the rectangular frame-shaped board, a degree of freedom in design according to arrangement of the light sources is improved as compared with the strip-shaped board (in this case, only the mounting places in one direction can be changed). Strength can be increased as compared with an end-shaped board such as a C-shaped board by using the frame-shaped board.

According to the configuration, the plurality of boards may be attached to the board attaching member. The board may include a first board and a second board. The second board having an outer shape smaller than that of the first board may be provided inside the first board in a plan view. The second board is provided inside the first board, and thereby the light sources can be provided in an inner side region of the first board. Therefore, the light sources can be provided on the board attaching member in a balanced manner.

### BRIEF DESCRIPTION OF THE DRAWINGS

FIG. 1 is an exploded perspective view illustrating a schematic configuration of a television receiver according to a first embodiment of the present invention;

FIG. 2 is an exploded perspective view illustrating a schematic configuration of a liquid crystal display device;

FIG. 3 is a plan view illustrating a plane configuration of a chassis including a light source in a backlight unit;

FIG. 4 is a cross sectional view taken along a line A-A in FIG. 3;

FIG. 5 is an enlarged view illustrating an enlarged circumference of an LED in FIG. 4;

FIG. 6 is an enlarged view illustrating a periphery of an LED in a cross-sectional view taken along the short-side direction of the backlight unit;

FIG. 7 is a plan view illustrating allotment of an LED board in a board producing step;

FIG. 8 is a plan view illustrating a condition where the board group different from the board group in FIG. 3 is attached to the chassis;

FIG. 9 is a plan view illustrating a comparative example;

FIG. 10 is a plan view illustrating a condition where one board group is attached to the chassis by sorting LED boards according to a second embodiment of the present invention into three different groups;

FIG. 11 is a plan view illustrating a condition where the board group different from the board group in FIG. 10 is attached to the chassis;

FIG. 12 is a plan view illustrating a condition where the board group different from the board group in FIGS. 10 and 11 is attached to the chassis; and

FIG. 13 is an enlarged cross-sectional view illustrating a periphery of the LED according to a third embodiment of the present invention.

### BEST MODE FOR CARRYING OUT THE INVENTION

### First Embodiment

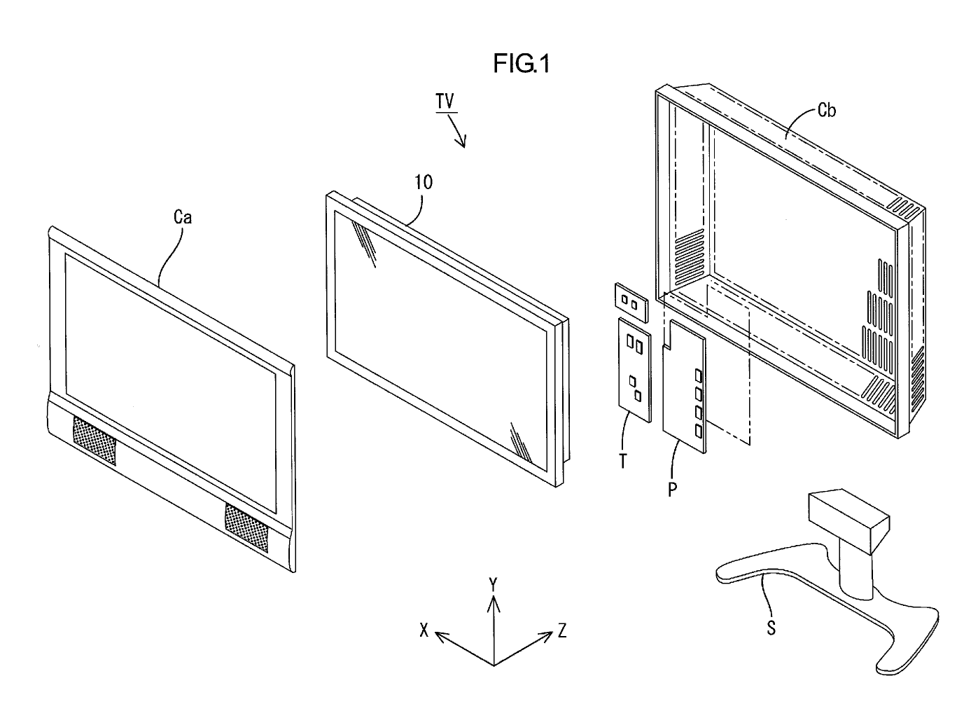

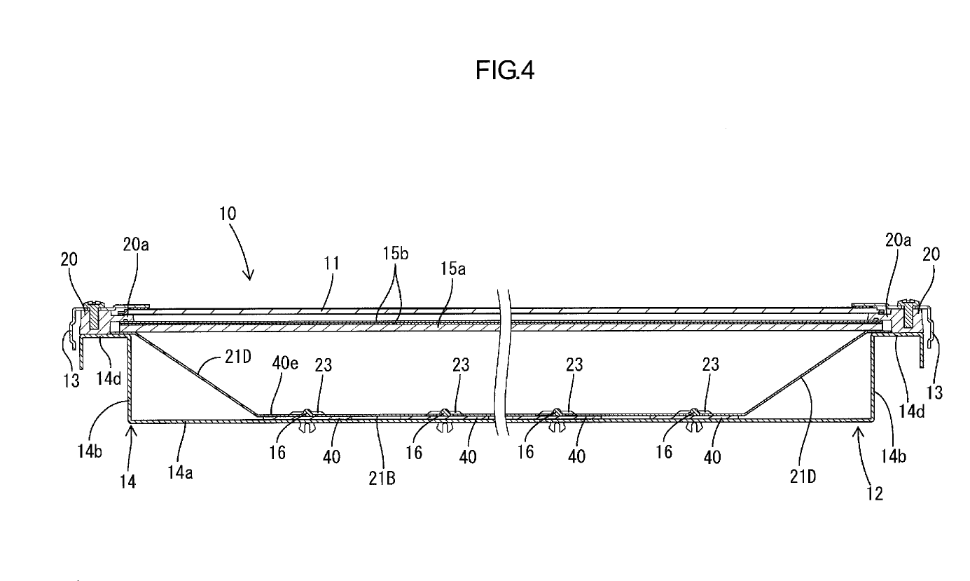

A first embodiment of the present invention will be described with reference to FIGS. 1 to 9. In the present embodiment, an X-axis, a Y-axis, and a Z-axis are shown in a part of each of the drawings. Directions of the axes are directions shown in each of the drawings. An upper side shown in FIG. 4 corresponds to a front side. A lower side thereof corresponds to a rear side.

(1) Configuration of Device

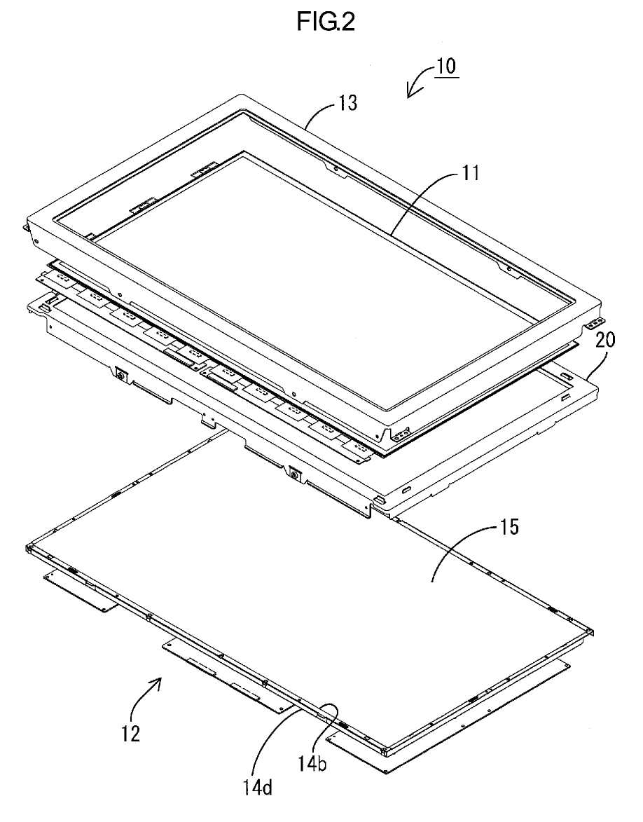

As illustrated in FIG. 1, the television receiver TV of the present embodiment includes the liquid crystal display device 10 (display device), front and rear cabinets Ca, Cb which house the liquid crystal display device 10 therebetween, a power source P, a tuner T and a stand S. The television receiver TV is supported by a stand S such that a display surface thereof matches a vertical direction (Y-axis direction). An entire shape of the liquid crystal display device (display device) 10 is a landscape rectangular. As illustrated in FIG. 2, the liquid crystal display device 10 includes a backlight unit 12 (lighting device) which is an external light source, and a liquid crystal panel 11 (display panel) configured to provide display using light from the lighting device 12. The liquid crystal panel 11 and the backlight unit 12 are integrally held by a frame shaped bezel 13 and the like.

Next, the liquid crystal panel 11 and the backlight unit 12 included in the liquid crystal display device 10 will be described. Of these, the liquid crystal panel 11 has a rectangular shape in a plan view. The liquid crystal panel 11 is configured such that a pair of glass substrates is bonded together with a predetermined gap therebetween and liquid crystal is enclosed between the glass substrates. One of the glass substrates is provided with switching elements (for example, TFTs) connected to source lines and gate lines that are perpendicular to each other, pixel electrodes connected to the switching elements, an alignment film, and the like. The other substrate is provided with a color filter having color sections such as R (red), G (green) and B (blue) color sections arranged in a predetermined pattern, counter electrodes, and an alignment film. Outer surfaces of the glass substrates have polarizing plates attached thereto. Polarizing plates are attached to outer surfaces of the substrates.

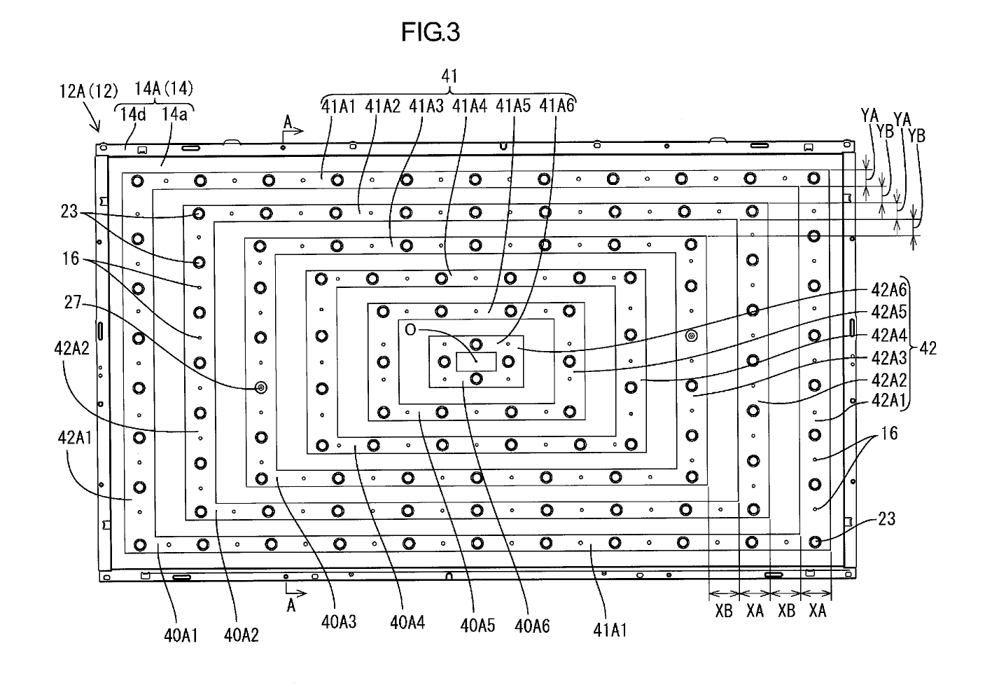

Then, the backlight unit 12 will be described in detail. As illustrated in FIGS. 3 and 4, the backlight unit 12 includes a chassis 14 (board attaching member) , a reflection sheet 21, a diffuser 15a, an optical sheet 15b, a plurality of LED boards 40, and a plurality of LEDs 16 (light emitting diode, light source, point light source). The chassis 14 is opened to a front side, and has a substantially box shape. The reflection sheet 21 is provided along an inner surface of the chassis 14. The diffuser 15a is provided so as to cover an opening of the chassis 14. The optical sheet 15b is laminated on a front side of the diffuser 15a. The LED boards 40 have different outer shapes, and are attached to the chassis 14. The LEDs 16 are mounted on each LED board 40.

The chassis 14 is made of metal such as aluminum-based material. An entire shape of the chassis 14 is a rectangular shape in a plan view like the liquid crystal panel 11. For example, an aspect ratio (a ratio of a horizontal size to a vertical size) of the chassis 14 in a plan view is set to 16:9. As illustrated in FIGS. 3 and 4, the chassis 14 includes a rectangular bottom plate 14a, side plates 14b each of which rises from an outer edge of the corresponding side of the bottom plate 14a, and a receiving plate 14d outwardly overhanging from a rising edge of each side plates 14b. The chassis 14 is provided with a long-side direction thereof aligned with a horizontal direction (X axis direction), and with a short-side direction aligned with a perpendicular direction (Y axis direction).

Next, the reflection sheet 21 will be described. The reflection sheet 21 is made of a synthetic resin, and has a surface having white color that provides excellent light reflectivity. The reflection sheet 21 is laid so as to cover substantially the entire area of the bottom plate 14a and inner surface sides of the side plates 14b of the chassis 14. The reflection sheet 21 can partially reflect light (for example, light which does not directly travel to the diffuser 15a from the LEDs 16, and light reflected by the diffuser 15a, and the like) emitted from the LEDs 16, to the diffuser 15a side, and thereby brightness of the backlight unit 12 can be increased. The reflection sheet 21 includes a bottom portion 21B provided along a plane direction (X axis and Y axis directions) of the chassis 14, and an inclined portion 21D extending from a peripheral edge portion of the bottom portion 21B. The inclined portion 21D is inclined so as to be directed to a center side of the liquid crystal display device 10 on a bottom plate 14a of the chassis 14. As illustrated in FIG. 4, the peripheral edge portion of the inclined portion 21D is supported by the receiving plates 14d of the chassis 14.

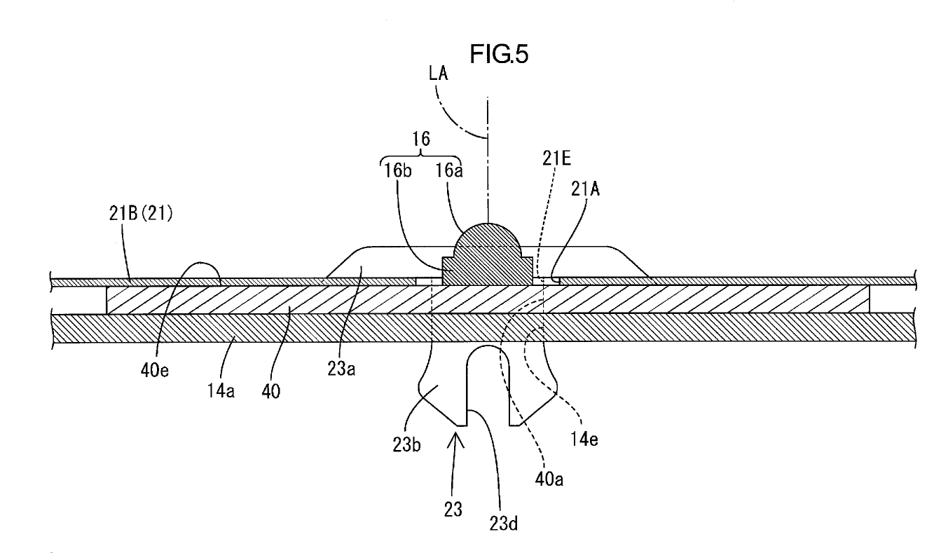

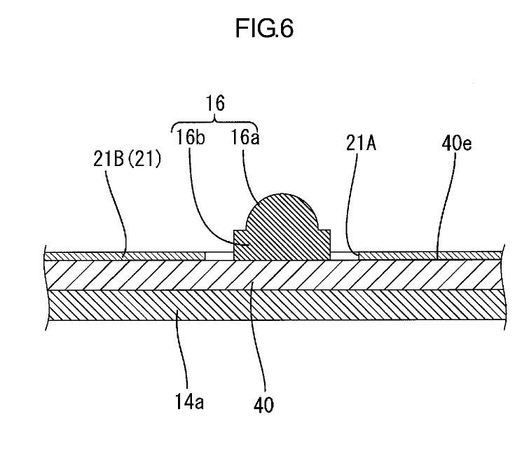

As illustrated in FIGS. 4 and 5, the bottom portion 21B of the reflection sheet 21 is superposed on a front surface 40e of the LED board 40. As illustrated in FIGS. 5 and 6, the bottom portion 21B has light source through holes 21A through which the LEDs 16 pass formed at places corresponding to the LEDs 16. The light source through hole 21A has a circular shape in a plan view, and has an outer diameter greater than that of the LED 16. Thereby, the LED 16 can pass through the light source through hole 21A, to be projected to the front side of the reflection sheet 21. The light from the LED 16 can be emitted to the diffuser 15a side without being interrupted by the reflection sheet 21. The LED 16 passes through the light source through hole 21A to prevent interference between the reflection sheet 21 and the LED 16. The outer diameter of the light source through hole 21A is greater than that of the LED 16 as described above. Thereby, even if an error of a size or a position occurs in each light source through hole 21A, the error can be permitted, and the LED 16 can be inserted into the light source through hole 21A. The outer diameter of the light source through hole 21A may be substantially the same as that of the LED 16. The reflection sheet 21 has clip inserting holes 21E into which inserting portions 23b of clips 23 to be described later can be inserted formed in the bottom portion 21B.

Next, the diffuser 15a and the optical sheet 15b will be described. The diffuser 15a has numerous diffusing particles dispersed in a transparent synthetic resin base material having a predetermined thickness, and has a function to diffuse transmission light. A plate thickness of each of the optical sheets 15b is thinner than a thickness of the diffuser 15a. The optical sheets 15b include a diffuser sheet, a lens sheet and a reflecting type polarizing sheet. These sheets can be suitably selected to be used.

The diffuser 15a has a peripheral edge portion superposed on the front side of the peripheral edge portion of the reflection sheet 21. The chassis 14 has a frame 20 fixed with a screw from the front side on the receiving plates 14d. The frame 20 has a protruding portion 20a protruding to an inner side of the chassis 14. The protruding portion 20a can press a peripheral edge portion of the optical sheets 15b from the front side. In the above configuration, the reflection sheet 21, the diffuser 15a, and the optical sheet 15b are held by the receiving plates 14d of the chassis 14 and a projecting portion 20a of the frame 20. The peripheral edge portion of the liquid crystal panel 11 is placed on the front side of the frame 20. The liquid crystal panel 11 can be held between the frame 20 and the bezel 13 provided on the front side.

Next, the LED boards 40 will be described. In the present embodiment, the plurality of rectangular frame-shaped LED boards 40 is provided on an inner surface of the bottom plate 14a of the chassis 14 so as to be concentric to a center O of the chassis 14 in a plan view. The LED boards 40 have outer shapes having different sizes. An aspect ratio of the outer shape of each LED board 40 is set to be the same (for example, 16:9) as that of the chassis 14. That is, the outer shape of each LED board 40 is almost similar in shape to that of the chassis 14, consequently, the backlight unit 12. The outer shape of the LED board 40 is made smaller toward the center side (center O) of the chassis 14 from the outer side thereof. For convenience in description, symbols 40A1 to 40A6 are applied to the LED boards 40 in order toward the inner side from the LED board 40 provided on the outermost side.

Thus, the outer shape of the LED board 40 is gradually made smaller to the inner side from the outer side, and thereby in an inner side region of an LED board 40 (first board), the other LED board 40 (second board) can be provided. For example, the LED board 40A2 (second board) is provided on the inner peripheral side of the LED board 40A1 (first board), and the LED board 40A3 is further provided on the inner peripheral side thereof. Therefore, the plurality of LED boards 40, consequently, the plurality of LEDs 16 is two-dimensionally arranged over the entire region of the bottom plate 14a of the chassis 14.

Next, the construction of each LED board 40 will be more specifically described. Because the LED boards 40A1 to 40A6 have the almost same configuration except that the LED boards 40A1 to 40A6 have different outer shape sizes (that is, lengths of a long-side portion 41 and a short-side portion 42 to be described later) and different numbers of the mounted LEDs 16, only the LED board 40A1 will be described herein. The LED board 40A1 is, for example, made of synthetic resin and has a surface on which a wiring pattern (not shown) including a metal film such as a copper foil is formed. The LED board 40A1 includes a pair of long-side portions 41A1 (41) extending in parallel along a long-side direction (X axis direction) of the chassis 14 and a pair of short-side portions 42A1 (42) extending in parallel along a short-side direction (Y axis direction) of the chassis 14. Both the ends of the long-side portions 41A1 facing each other in the Y axis direction are respectively connected by the short-side portions 42A1, and thereby the LED board 40A1 is formed into a frame shape as a whole. The LED board 40 may be metal such as aluminum-based material.

All widths YA of the long-side portions 41 (41A1 to 41A6) of the LED boards 40 (40A1 to 40A6) are set to the same value. All widths XA of the short-side portions 42 (42A1 to 42A6) of the LED boards 40 (40A1 to 40A6) are set to the same value. As illustrated in FIG. 3, in the Y axis direction, an interval YB between the long-side portions 41 of the adjacent LED boards 40 is set to be the same as the width YA of the long-side portion 41. In the X axis direction, an interval XB between the short-side portions 42 of the adjacent LED boards 40 is set to be the same as the width XA of the short-side portion 42.

The LED 16 is a so-called surface mounting type LED. As illustrated in FIG. 5, the LED 16 is mounted on the front surface 40e of the LED board 40 with an optic axis LA of the LED 16 being coaxial to a Z axis. The LED 16 includes a board portion 16a and a tip portion 16b having a semi-spherical shape. The LED 16 is obtained by combining an LED chip emitting blue single color light with a fluorescent material mixed in the tip portion 16b, to emit white color light. A rear surface of the board portion 16a of the LED 16 is soldered to a wiring pattern (not shown) formed on the LED board 40. As illustrated in FIG. 3, the LEDs 16 are linearly arranged along the extending directions of both the long-side portions 41 and both the short-side portions 42 of the LED board 40. An arranging pitch between the LEDs 16 is substantially constant. In other words, the LEDs 16 are arranged at equal intervals in both the long-side portions 41 and both the short-side portions 42. The LED board 40 has a connector which is not shown and a drive control circuit which is also not shown connected to the connector. Thereby, electrical power required for lighting of each LED 16 can be supplied from the drive control circuit, and each LED 16 can be driven and controlled.

Next, an attaching structure of the LED board 40 to the chassis 14 will be described. As illustrated in FIGS. 3 and 5, the LED board 40 has clip inserting holes 40a formed therethrough in front-rear directions (Z axis direction) at four corners of the LED board 40 and middle places between the adjacent LEDs 16. A clip 23 is inserted into the clip insertion hole 40a to fix the LED board 40 to the chassis 14. The chassis 14 has clip attaching holes 14e having the same diameter as that of the clip inserting hole 40a formed at places corresponding to the clip inserting holes 40a. The clip 23 is made of a synthetic resin, for example. As illustrated in FIG. 5, the clip 23 includes an attaching plate 23a being in parallel to the LED board 40 and having a circular shape in a plan view, and an inserting portion 23b projected to the chassis 14 side along the Z axis direction from the attaching plate 23a. The position of the clip inserting hole 40a can be suitably changed on the LED board 40.

The inserting portion 23b is set such that abase end side diameter thereof is slightly smaller than that of the clip inserting hole 40a, and is set such that a tip side diameter thereof is greater than that of the clip inserting hole 40a. The inserting portion 23b has a groove portion 23d having a shape denting to the front side formed in a tip portion thereof. Thereby, the tip portion of the inserting portion 23b can be elastically deformed in a radial direction. When the inserting portion 23b of the clip 23 is inserted into the clip inserting hole 40a and the clip attaching hole 14e according to the above constitution, the tip side of the inserting portion 23b is locked from the rear side of the chassis 14. Thereby, the LED board 40 is attached to the chassis 14 with the LED board 40 held between the attaching plate 23a of the clips 23 and the chassis 14. More precisely, the bottom portion 21B of the reflection sheet 21 is provided between the attaching plate 23a of the clip 23 and the LED board 40. The LED board 40 is pressed to the attaching plate 23a from the front side through the bottom portion 21B of the reflection sheet 21.

An approximate conical support pin 27 is projected to the front side from the surface of the clip 23 provided closer to the center of the chassis 14 (only a plan view is illustrated in FIG. 3). A height of the projected support pin 27 is set such that a tip portion thereof is in contact with (or close to) the rear surface of the diffuser 15a. Thereby, the support pin 27 supports the diffuser 15a from the rear side to have a function of suppressing bending of the diffuser 15a.

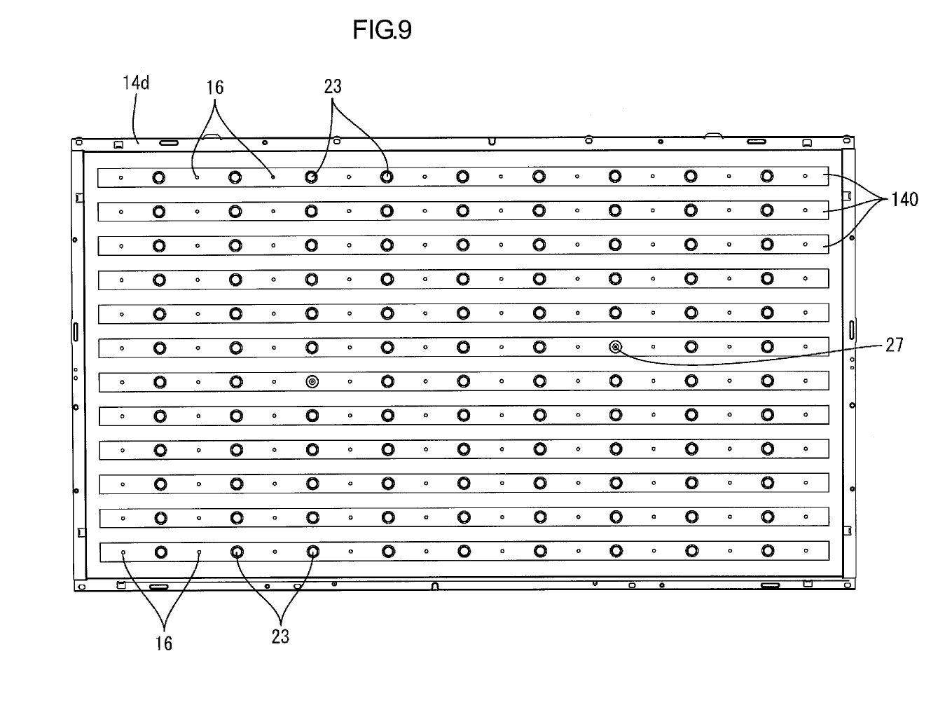

Next, the effect exhibited by the configuration of the present embodiment will be described. When the LEDs 16 are two-dimensionally provided on the inner surface of the chassis 14, for example, as illustrated in FIG. 9, the plurality of lines of strip-shaped LED boards 140 on which the plurality of LEDs 16 is arranged along the long-side direction is considered to be arranged along the short-side direction. In the present invention, the rectangular frame-shaped boards having four sides are used, and thereby, the total number of the LED boards can be reduced as compared with a configuration including the strip-shaped LED boards 140 when the LEDs 16 of the same line number are provided. For example, in the configuration of FIG. 9, the total number of the LED boards 140 is twelve (twelve lines). However, in the configuration of FIG. 3, the total number can be set to about half of that in the configuration of FIG. 9, that is, six.

Reduction in the total number of the LED boards facilitates attaching work of the LED boards, and thereby work cost can be reduced. Furthermore, the reduction in the total number of the LED boards can reduce the number of parts for a connector electrically connecting each LED board to the drive control circuit. Thereby, the connection work of the connector and the drive control circuit can be simplified, and the work cost can also be reduced. Because the position of the connector and the drive control circuit are decreased, a possibility of occurrence of a connection defect can be reduced. In that the total number of the LED boards is reduced, it is best to provide only one LED board having the almost same area as that of the arranging region of the light sources. However, when the board is configured as described above, the total weight and area of the LED boards are unpreferably increased.

The LED boards 40 are suitable when the mounting positions of the LEDs 16 are adjusted in the plane of the chassis 14. If the strip-shaped LED boards 140 are used, the mounting positions of the LEDs 16 can be adjusted in the extending direction (one direction, the X axis direction in FIG. 9) of each LED board 140. However, when the mounting positions of the LEDs 16 are adjusted in a direction (the Y axis direction in FIG. 9) crossing the extending direction, it is necessary to move the whole of the LED boards 140, that is, the lines of the LEDs 16 arrayed in the X axis direction all together. In this respect, the mounting position of the LEDs 16 can be adjusted in the extending directions (two directions) of the long-side portion 41 and the short-side portion 42, if the rectangular frame-shaped LED boards 40 are employed. Thus, for example, the LEDs 16 are provided closer to the center portion in the long-side portion 41 and the short-side portion 42 of the LED board 40, and thereby the LEDs 16 can also be concentrically provided on the center portion of the chassis 14. Strength can be increased as compared with an end-shaped board such as a C-shaped board by using the frame-shaped LED board 40.

The chassis 14 has the plurality of LED boards 40. The plurality of LED boards 40 has the first board (for example, the LED board 40A1) and the second board (for example, the LED board 40A2). The second board having an outer shape smaller than that of the first board is provided inside the first board in the plan view. The second board is provided inside the first board, and thereby the light sources can be provided in an inner side region of the first board. Therefore, the LEDs 16 can be provided on the bottom plate 14a of the chassis 14 in a balanced manner.

(2) Method of Manufacturing Backlight Unit

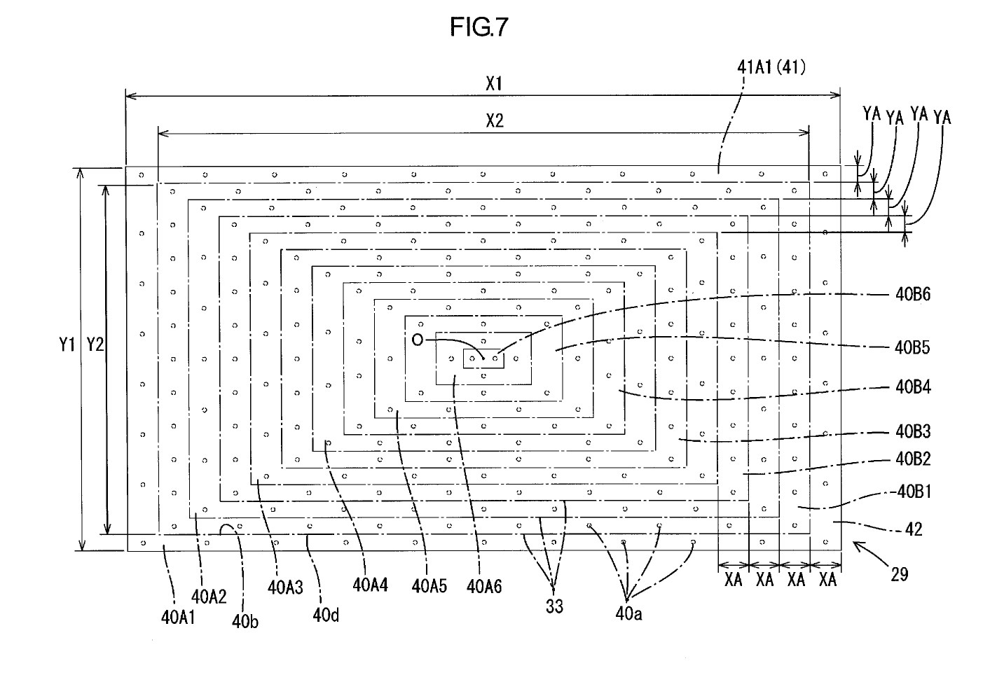

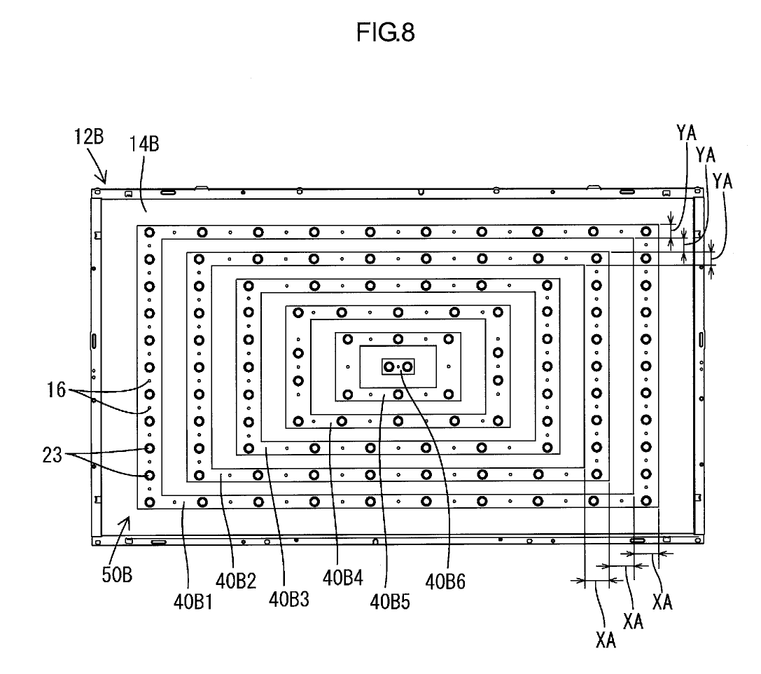

Next, a method of manufacturing the backlight unit 12 of the present embodiment will be described. In the present embodiment, the backlight unit 12 is manufactured through a board producing step of dividing one board base member 29 to produce a plurality (twelve, in FIG. 7) of LED boards 40 having different outer shapes, and a board attaching step of attaching the plurality of thus-produced LED boards 40 to the chassis 14. In the present embodiment, as illustrated in FIGS. 3 and 8, two backlight units 12A (12) and 12B are manufactured by sorting the plurality of LED boards 40 produced in the board producing step and respectively attaching the LED boards 40 to two chassis 14A (14) and 14B having the same size.

In the board producing step, as illustrated in FIG. 7, the plurality (twelve in FIG. 7) of LED boards 40 having different outer shapes is produced by dividing one rectangular board base member 29 having the same aspect ratio (16:9 in the present embodiment) as that of the LED board 40. First, a method of allotting the LED boards 40 to the board base member 29 will be described using the LED board 40A1 (the first board) provided on the outermost side and the LED board 40B1 (the second board) provided inside the LED board 40A1 (in a direction directed to the center O) as examples. A length X2 in the long-side direction of the LED board 40B1 provided on the inner side is set to be smaller by two times of the width XA of the short-side portion 42 of the LED board 40 than a length X1 in the long-side direction of the LED board 40A1 provided on the outer side. A length Y2 in the short-side direction of the LED board 40B1 provided on the inner side is set to be smaller by two times of the width YA of the long-side portion 41 than a length Y1 in the short-side direction of the LED board 40A1 provided on the outer side.

The LED board 40A1 and the LED board 40B1 can be allotted with the outer peripheral surface 40d of the LED board 40B1 being in contact with (or close to) the inner peripheral surface 40b of the LED board 40A1 in the plan view by the above size setting. Thus, the gap between the LED board 40A1 provided on the outer side and the LED board 40B1 provided on the inner side can be set to almost zero by allotting both the LED boards 40A1 and 40B1, and the board base member 29 can be used without wastes. The other LED boards 40 are also allotted on the board base member 29 as in the arrangement of the LED boards 40A1 and 40B1. That is, the LED boards 40 are configured such that a length in the long-side direction of the LED board 40 provided on the inner side is shorter by two times of the width XA of the short-side portion 42 and a length in the short-side direction is shorter by two times of the width YA of the long-side portion 41. Only the LED board 40B6 provided on the innermost side has not a rectangular frame shape but a rectangular shape.

Next, a circuit pattern is formed on the board base member 29 on which the plurality of LED boards 40 is allotted, by the above allotting method (a land on which the LEDs 16 are mounted, and a wiring line connecting lands, and the like are formed). The circuit pattern can be formed by an etching method and the like as in manufacture of a usual printed-circuit board.

Next, perforations 33 corresponding to the outer shape of each LED board 40 allotted according to the above allotting method are formed in the board base member 29. The LEDs 16 and the connector are mounted at positions corresponding to the LED boards 40 in the board base member 29 in which the perforations 33 are formed, by reflow soldering (mounting step). For example, parts such as the LEDs 16 and the connectors are mounted so as to correspond to the land on which cream solder is applied. Then, the parts are heated in a reflow furnace to melt the cream solder. Thereby, the LEDs 16 and the connectors are electrically connected. Thus, the LEDs 16 and mounted parts such as the connector can be collectively mounted before the board base member 29 is divided into the LED boards 40, which produce good workability. The perforations 33 may be formed after the mounting step.

Next, the board base member 29 after the mounting step is split along the perforations 33. Places in which the perforation 33 is not opened are cut by using jigs such as a Thomson die cutter. Thereby, the board base member 29 is divided into the plurality of LED boards 40 (the LED boards 40A1 to 40A6 and the LED boards 40B1 to 40B6) having the same aspect ratio and different outer shapes (board producing step).

As illustrated in FIGS. 3 and 8, for example, the plurality of LED boards 40 produced as described above is sorted into two groups (the board group 50A and the board group 50B). The groups are respectively attached to the separate chassis 14A (14) and 14B. Specifically, the board group 50A is configured by sorting the LED boards 40 alternately provided to the inner side (the center O side) from the outermost LED board 40A1 (the LED board provided in the first position from the outer side) in FIG. 7, that is, the LED boards 40A1 to 40A6. On the other hand, the board group 50B is configured by sorting the LED boards 40 alternately provided to the inner side from the LED board 40B1 provided in the second position from the outer side, that is, the LED boards 40B1 to 40B6.

Next, the LED boards 40A1 to 40A6 belonging to the board group 50A are arranged on the bottom plate 14a of the chassis 14A. Next, the reflection sheet 21 is laid along the inner surface of the chassis 14A. Specifically, each light source through hole 21A of the reflection sheet 21 is housed in the chassis 14A while the light source through hole 21A is positioned to each LED 16. Then, while each LED 16 passes through each light source through hole 21A, the bottom portion 21B of the reflection sheet 21 is laid on the front surface 40e of each of the LED boards 40A1 to 40A6. The peripheral edge portion of the inclined portion 21D is placed on each receiving plate 14d of the chassis 14A simultaneously with the above work.

Next, the clip 23 is attached from the front side of the reflection sheet 21. Specifically, the inserting portion 23b of the clip 23 is inserted into the clip inserting hole 21E of the reflection sheet 21, the clip inserting hole 40a of the LED board 40, and the clip attaching hole 14e of the chassis 14A in this order. Thereby, the tip side of the inserting portion 23b is locked from the rear side of the chassis 14A. Therefore, as illustrated in FIG. 3, the LED boards 40A1 to 40A6 are attached to the chassis 14A (board attaching step).

Next, the diffuser 15a has a peripheral edge portion superposed on the front side of the peripheral edge portion of the reflection sheet 21. The optical sheet 15b is placed on the front side of the diffuser 15a. Thereby, the diffuser 15a and the optical sheet 15b are provided so as to cover the opening of the chassis 14A. The backlight unit 12A is completed according to the above procedure.

As illustrated in FIG. 8, the LED boards 40B1 to 40B6 belonging to the board group 50B are attached to the chassis 14B (board attaching step). The backlight unit 12B is completed by attaching the reflection sheet 21, the diffuser 15a, and the optical sheet 15b to the chassis 14B. Because a specific method of attaching parts is the same as that in the case of the backlight unit 12A, the description thereof is eliminated here. In FIGS. 3 and 8, the illustration of the reflection sheet 21 is eliminated.

Next, the effect of the manufacturing method in the present embodiment will be described. When the rectangular frame-shaped LED boards 40 are dividedly formed from one board base member 29 in the present embodiment, the board base member 29 is divided into the LED boards 40 such that the inner peripheral surface of an LED board (for example, the LED board 40A1) is in contact with (or close to) the outer peripheral surface of the other LED board (for example, the LED board 40B1). Thereby, because the gap between the LED boards 40 can be set to almost zero, wastes of the board base member 29 can be reduced. However, as illustrated in the backlight unit 12 of FIG. 3, the LED boards 40 are provided at a prescribed interval on the chassis 14. This configuration is employed in order to set the interval between the LEDs 16 (the interval between the LED boards 40) to be as large as possible within a range causing no brightness unevenness in light emitted from the backlight unit 12 to reduce the total number of the LEDs 16, thereby reducing parts cost and power consumption.

That is, as illustrated in FIG. 3, even if the LED boards 40 are divided as illustrated in FIG. 7 when the LED boards 40 are provided at an interval, all the divided LED boards 40 cannot be used for one backlight unit 12. The LED boards 40 which are not used are useless. Then, after the plurality of LED boards 40 is formed from one board base member 29 in the present embodiment, the plurality of LED boards 40 is respectively used for two backlight units 12A and 12B. That is, while the LED boards 40A1 to 40A6 used for the backlight unit 12A are allotted to the board base member 29, the remaining portions are allotted as the LED boards 40B1 to 40B6 used for the other backlight unit 12B, to divide the board base member 29 to the LED boards 40. Thereby, while the LED boards 40 are rectangular frame-shaped, the board base member 29 can be used without wastes, and cost reduction can be attained.

When both the board groups 50A and 50B are sorted in the present embodiment, the LED boards 40 alternately provided toward the inner side are respectively sorted. The outer shapes of the LED boards 40 are comparatively close in both the board groups 50A and 50B according to the sorting. As the outer shapes of the LED boards 40 in the board group 50A are close to those of the LED boards 40 in the board group 50B, the arranging positions of the LEDs 16 in both the backlight units 12A and 12B can be brought close to each other. Thus, both the backlight units 12A and 12B can be provided as products having the same performance. The number of the LEDs 16 provided on the backlight unit 12A is approximately the same as that on the backlight unit 12B. For example, 114 pieces of LEDs 16 are provided on the backlight unit 12A, and 111 pieces of LEDs 16 are provided on the backlight unit 12B. Thereby, brightness of the backlight unit 12A is almost the same as that backlight unit 12B.

As described above, the method of manufacturing the backlight unit in the present embodiment includes the plurality of LEDs 16, the LED boards 40 on which the LEDs 16 are mounted, and the chassis 14 to which the LED boards 40 are attached. The method includes a board producing step of dividing one board base member 29 into a plurality of rectangular frame-shaped LED boards 40 having the same aspect ratio as that of the board base member 29 to produce the LED boards 40, and a board attaching step of attaching the LED boards 40 to the chassis 14. The board base member 29 is divided into at least the first board and the second board of the LED boards 40 such that the second board having an outer shape smaller than that of the first board is allotted inside the first board in the plan view in the board producing step.

Thus, the plurality of LED boards 40 having the same aspect ratio and different outer shapes can be formed from one board base member 29. Because the second board (for example, the LED board 40B1) is provided inside the first board (for example, the LED board 40A1) in the plan view, the board base member 29 can be used without wastes as compared with a configuration in which both the boards are arranged next to each other on the board base member 29.

The board base member 29 is divided into at least the first board and the second board with the outer peripheral surface of the second board (for example, the outer peripheral surface 40d of the LED board 40B1) being in contact with or close to the inner peripheral surface of the first board (for example, the inner peripheral surface 40b of the LED board 40A1) in the board producing step. The outer peripheral surface of the second board is in contact with or close to the inner peripheral surface of the first board. Thereby, a gap between the first board and the second board can be set to almost zero. This can produce a superior yield of the board base member 29 to reduce cost. When the board base member is divided into the first board and the second board in the present embodiment, a size of an outer shape of the first board is close to that of the second board. Thereby, the first board and the second board having the same size can be respectively used for two lighting devices.

The method may further include mounting the LEDs 16 on the board base member 29 so as to correspond to each LED board 40 before the dividing step. Because the method collectively mounts the LEDs 16 before dividing the board base member 29 into the plurality of LED boards 40, the method provides good workability.

### Second Embodiment

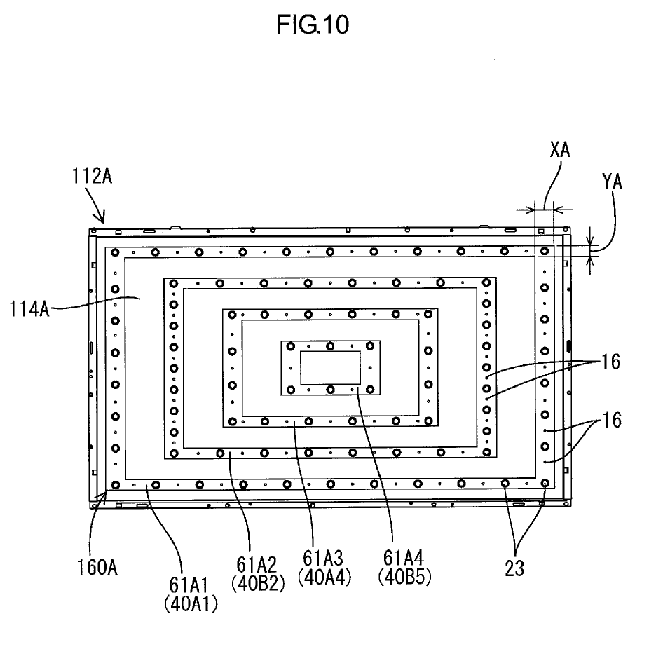

Next, a second embodiment of the present invention will be described with reference to FIGS. 10 to 12. In the second embodiment, constituent parts having the same names as those of the above first embodiment are indicated by the same symbols without repeating overlapping descriptions of structures, operations, and effects. In the method of manufacturing the LED boards in the above first embodiment, the plurality of LED boards 40 is sorted into two groups (50A and 50B) in the board attaching step. The groups are respectively attached to two backlight units. In the board attaching step in the present embodiment, as illustrated in FIGS. 10 to 12, the plurality of LED boards 40 is sorted into three board groups 160A, 160B, and 160C. The three board groups 160A, 160B, and 160C are respectively attached to three chassis 114A, 114B, and 114C.

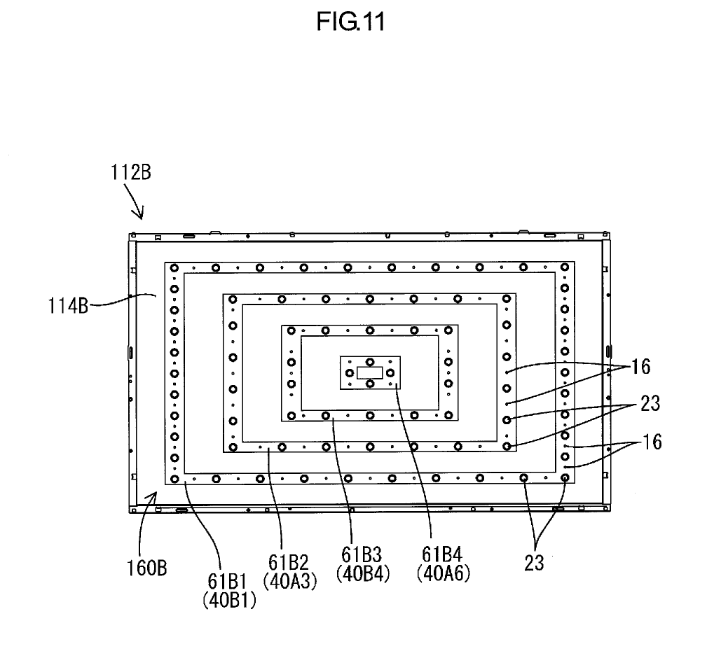

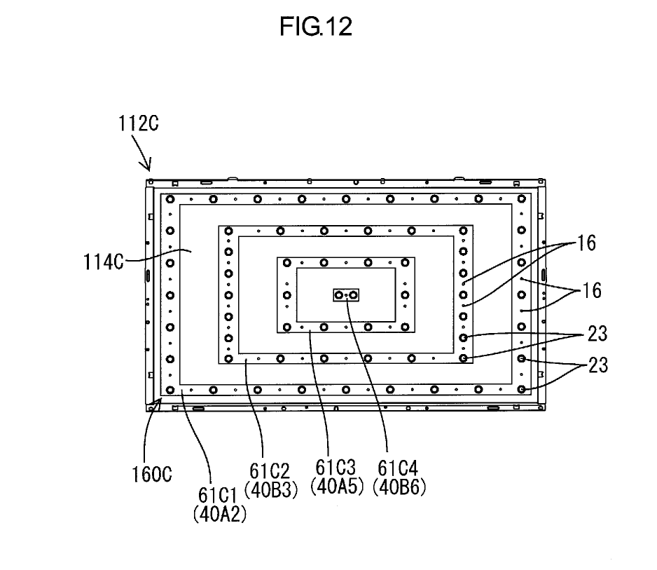

Next, the board groups 160A, 160B, and 160C will be specifically described. As illustrated in FIG. 10, the board group 160A is configured by sorting every three LED boards provided toward the inner side from the LED board 61A1 (40A1) provided on the outermost side in FIG. 7, that is, the LED boards 61A1 to 61A4. As illustrated in FIG. 11, the board group 160B is configured by sorting every three LED boards provided toward the inner side from the LED board 61B1 (40B1) provided in the second position from the outer side in FIG. 7, that is, the LED boards 61B1 to 61B4. As illustrated in FIG. 12, the board group 160C is configured by sorting every three LED boards provided toward the inner side from the LED board 61C1 (40A2) provided in the third position from the outer side in FIG. 7, that is, the LED boards 61C1 to 61C4. The LED boards 61 in FIGS. 10 to 12 are the same as the LED boards 40 in FIG. 7. However, for convenience in description, different symbols are applied.

In the above first embodiment, each board group is attached to the chassis having the same size. On the other hand, in the present embodiment, each board group is used for a backlight unit having a different size. For example, as shown in FIGS. 10 and 11, a size of an outer shape of each LED board in the board group 160A is comparatively close to that in the board group 160B. The board group 160A and the board group 160B are respectively attached to the chassis 114A and 114B having the same size, to configure backlight units 112A and 112B having the same size. As illustrated in FIG. 12, the board group 160C having LED boards with a comparatively small outer shape is attached to the chassis 114C having a size smaller than those of the chassis 114A and 114B, to configure a backlight unit 112C having a size smaller than those of the backlight units 112A and 112B. The LED boards 61 in each of the board groups 160A, 160B, and 160C are arranged so as to be concentric to a center O of each chassis 114 to which the LED boards 61 are attached in the plan view. As described above, the LED boards 61 for three backlight units can be obtained from one board base member 29 by sorting the LED boards 40. The board groups 160A to 160C may be respectively attached to the chassis having the same size. The board groups 160A to 160C may be respectively attached to the chassis having different sizes.

### Third Embodiment

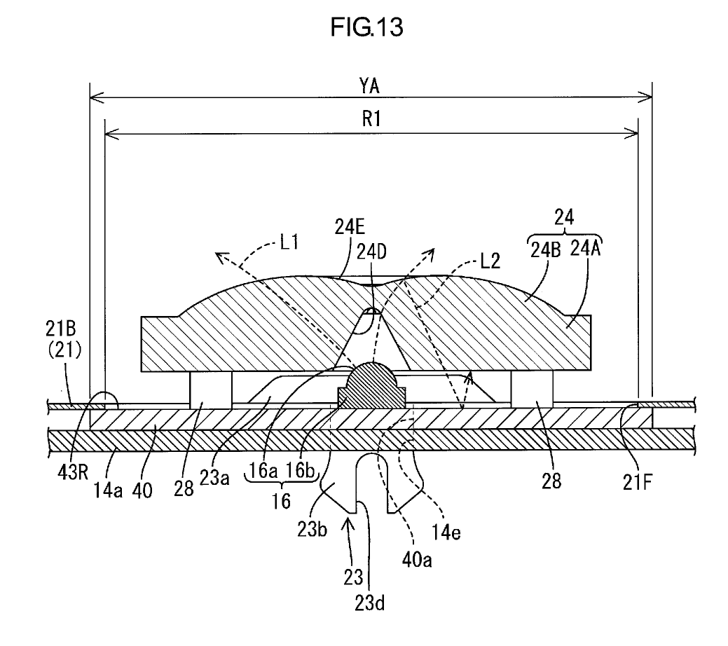

Next, a third embodiment of the present invention will be described with reference to FIG. 13. In the third embodiment, constituent parts having the same names as those of the above embodiments are indicated by the same symbols without repeating overlapping descriptions of structures, operations, and effects. In the present embodiment, the LED board 40 has a diffuser lens 24 is provided on the front side of each LED 16. The diffuser lens 24 is formed of a transparent member (for example, acrylic and polycarbonate) having a refractive index higher than that of air. The diffuser lens 24 functions to refract light emitted from each LED 16 to diffuse the light. The diffuser lens 24 has a circular shape in a plan view, and the LED 16 is provided at a center thereof. The diffuser lens 24 is provided so as to cover the front side of the LED 16. The diffuser lens 24 includes a base portion 24A having a circular plate shape in a plan view and a flat spherical portion 24B having a flat semi-spherical shape. Leg portions 28 are provided so as to be projected to the rear side from the peripheral edge portion of the base portion 24A in the plan view. For example, the leg portions 28 are bonded to the LED board 40 by an adhesive or a thermosetting resin and the like, and thereby the diffuser lens 24 is fixed to the LED board 40.

The diffuser lens 24 has a concave portion 24D having a substantially conical shape formed in a lower surface thereof by denting a place located immediately above the LED 16 to the front side (upper side of FIG. 13). Each of the diffuser lenses 24 has a concave portion 24E having an substantially mortar shape formed in a top portion thereof. The concave portion 24E includes an inner peripheral surface having a circular arc shape in a section view. The light from the LED 16 is refracted over a wide angle on a boundary between the diffuser lens 24 and air by such a configuration, and is diffused to circumference of the LED 16 (allow L1 of FIG. 13). A part of the light is reflected on a boundary between the concave portion 24E of each of the diffuser lenses 24 and air (allow L2 of FIG. 13). Thereby, a phenomenon in which the top portion of each of the diffuser lenses 24 is brighter than circumference thereof can be prevented, and uneven brightness can be suppressed.

The reflection sheet 21 has a lens inserting hole 21F having a diameter enabling insertion of the diffuser lens 24 is formed at a position corresponding to the diffuser lens 24 in the plan view in the bottom portion 21B. Thereby, the reflection sheet 21 can be laid in a state where the diffuser lens 24 is projected to the front side of the reflection sheet 21 by inserting the diffuser lens 24 into the lens inserting hole 21F. The LED board 40 has a front surface on which a reflection surface 43R for reflecting light to the front side is formed. The reflection surface 43R is formed by printing a paste containing an metal oxide on the surface of the LED board 40. The paste can be printed by, for example, screen printing, ink jet printing or the like. Thereby, the lens inserting hole 21F is formed, and when light is made incident on the region R1 corresponding to the lens inserting hole 21F, the light is reflected to the front side (particularly, the diffuser lens 24 side) by a reflection surface 43R. This can increase brightness. Another reflection sheet which is different from the reflection sheet 21 may be laid so as to overlap with the front surface of the LED board 40 in the plan view instead of forming the reflection surface 43R on the front surface of the LED board 40.

As described above, in the configuration including the diffuser lens 24, the light emitted from the LED 16 is diffused by the diffuser lens 24. Thereby, the region between the LEDs 16 is hardly recognized visually as a dark portion even if the interval between the LEDs 16 that are adjacent to each other and widely set. Therefore, the total number of the LEDs 16 provided on the inner surface of the chassis 14 can be reduced, and power consumption and part cost required for the LEDs 16 can be reduced. Because the interval between the adjacent LEDs 16 can be widely set, the interval between the LED boards 40 can be widely set. Therefore, the total number of the LED boards 40 in the backlight unit can be reduced. The cost of the LED boards 40 required for configuring one backlight unit can further be reduced as compared with the configuration of above each embodiment. For example, in the chassis 14 illustrated in FIG. 3 of the first embodiment, the LED boards 40A2, 40A4, and 40A6 of the LED boards 40A1 to 40A6 may be abandoned, and these LED boards 40A2, 40A4, and 40A6 can also be diverted to the other backlight units.

### Other Embodiment

As describe above, the embodiments of the present invention have been described. However, the present invention is not limited to the above embodiments described in the above description and the drawings. The following embodiments are also included in the technical scope of the present invention, for example.

(1) In the above first embodiment, the board base member 29 is divided into the LED boards 40 such that the inner peripheral surface of an LED board (for example, the inner peripheral surface 40b of the LED board 40A1) is in contact with (or close to) the outer peripheral surface of the other LED board (for example, the outer peripheral surface 40d of the LED board 40B1) in the plan view. However, the present invention is not limited thereto. In the plan view, an LED board may be provided inside the other LED board.

(2) In the above embodiments, the aspect ratio of the outer shape of each LED board 40 is set to be the same (16:9) as that of the chassis 14. However, the present invention isnot limited thereto. The aspect ratio of the outer shape of the LED board 40 may be set to be different from that of the outer shape of the chassis 14. The aspect ratio may not be set to 16:9.

(3) In the above embodiments, all the outer shapes of the plurality of LED boards 40 have the same aspect ratio. However, the present invention is not limited thereto. All the outer shapes of the LED boards 40 may have different aspect ratios.

(4) In the above embodiments, the plurality of LED boards 40 is provided so as to be concentric to the center O of the chassis 14 in the plan view. However, the present invention is not limited thereto. The LED boards 40 may be provided with the centers thereof deviated from the center O.

(5) In the above embodiments, the board base member 29 is divided to form the twelve LED boards 40. However, the present invention is not limited thereto. The LED boards less than twelve or more than twelve may be formed by changing the widths of the long-side portion 41 and the short-side portion 42 of the LED board 40.

(6) In the above embodiments, all the widths of the long-side portions 41 of the LED boards 40 are set to the same value. However, the present invention is not limited thereto. The width of the long-side portion 41 may be changed for each LED board 40. The width of the short-side portion 42 of each LED board 40 may also be changed for each LED board 40.

(7) In the above embodiments, the LEDs 16 are provided at equal intervals along the extending directions in the long-side portion 41 and the short-side portion 42 of the LED board 40. However, the present invention is not limited thereto. The arranging places and the number of the LEDs 16 in the LED board 40 can be suitably changed.

(8) In the above embodiments, the plurality of LED boards 40 formed by dividing the board base member 29 is sorted into two or three board groups, and the board groups are respectively used for the different backlight units. However, the present invention is not limited thereto. For example, all the plurality of LED boards 40 maybe attached to one backlight unit. The plurality of LED boards 40 may be sorted into four or more board groups to respectively use the board groups for four or more backlight units.

(9) In the above embodiments, the LEDs 16 including the blue light emitting LED chip and the fluorescent material are exemplified. However, the present invention is not limited thereto. For example, each of the LEDs 16 may include an ultraviolet-emitting LED chip and a fluorescent material. Or, each of the LEDs 16 may include three kinds of LED chips emitting R (red), G (green), and B (blue) single color light. The three kinds of LED chips emitting R (red), G (green), and B (blue) single color light may be combined.

(10) The configurations of the diffuser 15a and the optical sheet 15b may be different from those of the above embodiments, and may be suitably changed. Specifically, the number of the diffusers 15a, and the number and kind and the like of the optical sheets 15b can be suitably changed. A plurality of optical sheets 15b of the same kind can also be used.

(11) In the above embodiment, the LEDs 16 used as the light sources are exemplified. However, the light sources other than the LEDs may be used.

(12) In the above embodiments, the chassis 14 is arranged such that the short-side direction thereof is aligned with the vertical direction. However, the chassis 14 may be arranged such that the long-side direction thereof is aligned with the vertical direction.

(13) In the above embodiments, TFTs are used as switching elements of the liquid crystal display device. However, the technique can be applied to liquid crystal display devices including switching elements other than TFTs (for example, thin film diode (TFD)). The technique can be applied not only to color liquid crystal display devices but also to black-and-white liquid crystal display devices.

(14) In the above embodiments, the chassis 14 is made of metal. For example, the chassis 14 may be made of a synthetic resin. Thus, the weight saving and cost reduction of the chassis 14 can be achieved.

(16) In the above embodiments, the liquid crystal display device 10 including the liquid crystal panel 11 as a display element is exemplified. However, the present invention can be applied to display devices including other types of display elements.

(16) In the above embodiments, the television receiver TV including the tuner T is exemplified. However, the present invention can also be applied to a display device including no tuner.

1: A lighting device comprising:
a plurality of light sources;
a rectangular frame-shaped board on which the light sources are mounted; and
a board attaching member to which the board is attached.

2: The lighting device according to claim 1, wherein the board includes a plurality of boards attached to the board attaching member, the plurality of boards including a first board and a second board, the second board having an outer shape smaller than that of the first board being arranged inside the first board in a plan view.

3: The lighting device according to claim 2, wherein the first board and the second board are configured with a same aspect ratio.

4: The lighting device according to claim 1, wherein the board is configured with a same aspect ratio as that of the board attaching member.

5: A display device comprising:
the lighting device according to claim 1; and
a display panel configured to provide display using light from the lighting device.

6: The display device according to claim 5, wherein the display panel is a liquid crystal panel using liquid crystals.

7: A television receiver comprising the display device according to claim 5.

8: A method of manufacturing a lighting device including a plurality of light sources, lighting device boards on which the light sources are mounted, and a board attaching member to which the lighting device boards are attached, the method comprising:
dividing a rectangular board base member into a plurality of rectangular frame-shaped boards including a t least a first board and a second board to produce the lighting device boards, each rectangular frame-shaped board having a same aspect ratio as that of the board base member; and
attaching the lighting device boards to the board attaching member,
wherein the first board and the second board of the lighting device boards are defined in the board producing step such that the second board has an outer shape smaller than that of the first board so as to be arranged inside the first board in a plan view.

9: The method according to claim 8, wherein the board base member is divided into at least the first board and the second board with an outer peripheral surface of the second board being in contact with or close to an inner peripheral surface of the first board in the board producing step.

10: The method according to claim 8, further comprising mounting the light sources on the board base member so as to correspond to each of the lighting device boards before dividing.
